(19) United States
(12) Patent Application Publication
(10) Pub. No.: US 2008/0274778 A1
(43) Pub. Date: Nov. 6, 2008

(54) Modular Combine Harvesting Machines

(76) Inventor: Robert John Eyre, Alford (GB)

Correspondence Address: JACKSON WALKER, L.L.P., 112 E. PECAN, SUITE 2400, SAN ANTONIO, TX, 78205, US

(21) Appl. No.: 11/793,167

(22) PCT Filed: Dec. 14, 2005
(86) PCT No.: PCT/GB2005/050246

§ 371 Date: Mar. 11, 2008

(30) Foreign Application Priority Data
Dec. 14, 2004 (GB) 0427283.7

(51) Int. Cl. A01D 41/04

(52) U.S. Cl. 460/119

(57) ABSTRACT

A grain cleaning module, adapted to be fitted to a grain cart (1) having means to deliver cleaned grain to collection means, includes a cleaning stage comprising at least one hollow cylinder (4) adapted to be mounted to said cart and means for causing the grain and waste material to pass through the one or more cylinders so that the grain can pass into the grain cart and the waste material can pass through the one or more cylinders for subsequent discharge. Each cylinder includes an outer sieve containing a rotary assembly carrying brushes arranged in a spiral to brush against the inside of the sieve and thereby to increase separation of grain and waste. The grain falls to the bottom of the cart where it can be moved by an auger to a chute and then out to another grain cart for example. A modular combine harvester includes a cutting head fitted to a tractor, a cart towed by the tractor and fitted with the module, and a conveyor module to carry the cut material from the header to the cart.

### FIELD OF THE INVENTION

The present invention concerns harvesting machines, in particular harvesting machines for grain crops that can replace traditional combine harvesters.

### BACKGROUND TO THE INVENTION

For many years the traditional combine harvester has been taken to represent the most efficient way of harvesting grain crops. As is well known, such machines cut down the crop, extract the grain and chaff from the stalks, separate out the grain and discharge the stalks and chaff whilst channeling the grain to a storage tank in the harvester. When the storage tank is full, it is discharged into a trailer or grain cart. The grain cart is generally driven to a grain silo, for example, and the empty cart returns to the harvester for the next load. All of this takes time and can lead to down time as the distance between harvester and silo increases.

There are various problems that existing harvesters experience, such as the down time mentioned above, choking within the mechanism, and thus limitations on harvesting speed. However, one of the most serious disadvantages of combine harvesters is the huge capital investment, coupled with the large proportion of time in the farming year that the machine is not in use.

A conventional combine harvester includes a reel to guide the crop into a cutting header, where at least the seed-bearing part of the crop is cut off. Generally, an auger guides the cut crop on to a central conveyor to carry the crop into a threshing stage where it is forced between rotary blades and a curved guide to separate out the seeds. The remaining crop waste progresses along the machine to a discharge outlet. The separated seeds are conveyed to a storage tank via sieves to separate chaff. The discharge auger is almost invariably located to one side of the machine, thereby dictating the side of the harvester where the grain cart has to be driven. Various cleaning stages may be deployed to ensure that the extracted grain is as free of chaff as possible and that the chaff and stalks are removed efficiently from the various mechanisms to prevent clogging and choking.

While the width of the header can be increased to increase the cutting rate, the greater quantity of cut material is all concentrated through the body of the harvester for processing. Improvements in combine harvesters have thus tended to concentrate on increasing the throughput of grain and chaff and the extraction rate of separated grain. This requires ever more powerful and heavy harvesters, with greater fuel consumption and increased capital cost. The greater weight also leads to greater soil compaction.

It has already been proposed in GB 2351219 to provide a header unit that can be attached to a self-powered vehicle, typically a tractor, so that the crop can be cut and the grain separated in a modular unit that can be relatively easily attached to and removed from the tractor as required. When not in use for harvesting, the tractor is available for alternative use and the header unit can be stored more easily than can a combine harvester. Maintenance of the header unit is also facilitated.

In the header unit of the above patent, an additional threshing/cleaning stage can be mounted on top of the header. The separated grain is delivered to a collector of some sort, such as a grain cart, and the stalk and chaff discharged onto the ground.

The present invention takes modularity a stage further so as to provide a complete solution to the combined problems of efficient seed crop harvesting and reducing the idle time of conventional harvesters.

### SUMMARY OF THE INVENTION

The invention provides a seed cleaning module adapted to be removably mounted on to the open upper face of a grain cart having means to deliver cleaned grain to collection means, the module including a cleaning stage comprising a sieve and transport means for moving harvested seeds and waste material over the surface thereof whereby the seeds fall into the cart and the waste material passes towards the rear of the cart for subsequent discharge.

Preferably, the sieve is in the form of a cylinder and the transport means is arranged to transport said seeds and waste material along the cylinder so that the seeds can pass therethrough into said grain cart and said waste material is carried along the cylinder for subsequent discharge at the end thereof.

The or each said cylinder may comprise an outer tubular sleeve, at least the lower part of which is perforated to allow grain to pass therethrough, and an inner tubular structure on which are mounted brush means adapted to brush against the inner surface of said outer sleeve.

The inner surface of the outer sleeve may be formed with a pattern of ribs to aid brushing and the inner tubular structure may comprise a sleeve provided with brush means on its outer surface. The brush means may be at least one brush disposed in a spiral. The transport means may also comprise angled solid bars, for example rubber bars, or a continuous spiral, on the outer surface of the inner tubular structure.

The cart may further include a hopper located upstream of the at least one cylinder and adapted to receive grain and waste material cut from a cutter.

The means for causing grain and waste material to pass through said one or more cylinders may comprise means to create an air flow through the one or more cylinders.

A collecting chamber may be located at the downstream end of the one or more cylinders and adapted to receive said waste material emerging from said one or more cylinders. There may also be discharge means to cause said waste material in said chamber to discharge from the cart and delivery means to deliver cleaned grain to a discharge device.

The discharge device conveniently comprises a delivery auger adapted to deliver said cleaned grain to a mobile collection cart. The auger is preferably movable so as to be disposed at either side of the said module. It may be mounted at the rear or front end of the grain cart, relative to the direction of travel of the cart in use.

There are preferably a plurality of said cylinders disposed side-by-side and parallel to the longitudinal axis of the module.

The invention also encompasses a grain cart provided with a module as set out in any of the preceding paragraphs. The grain cart may have feeding means for feeding said cleaned grain to said delivery means. The feeding means may comprise an auger disposed in the base of said cart.

In addition, the invention encompasses a modular harvesting machine comprising a cutting head mounted to a tractor, and a conveyor module mounted to the tractor to carry grain and waste material cut from the cutting head to a grain cart provided with a module as set out in the previous paragraphs.

It will be appreciated that, while the grain cart will typically be a trailer vehicle towed, for example, by an agricultural tractor, it may also be a self-propelled vehicle.

### BRIEF DESCRIPTION OF THE DRAWINGS

Preferred embodiments of the invention will now be described with reference to the drawings, in which:

FIG. 1 is a perspective diagrammatic view of a grain cart incorporating the present invention;

FIG. 2 is a side elevation of the cart of FIG. 1 showing various flow paths;

FIG. 3 is a rear end view of the cart;

FIG. 4 is a perspective view of an inner brush assembly;

FIG. 5 is a perspective view of an outer sieve structure; and

FIG. 6 is a diagrammatic plan view of a complete harvester employing the invention.

### DETAILED DESCRIPTION OF THE ILLUSTRATED EMBODIMENTS

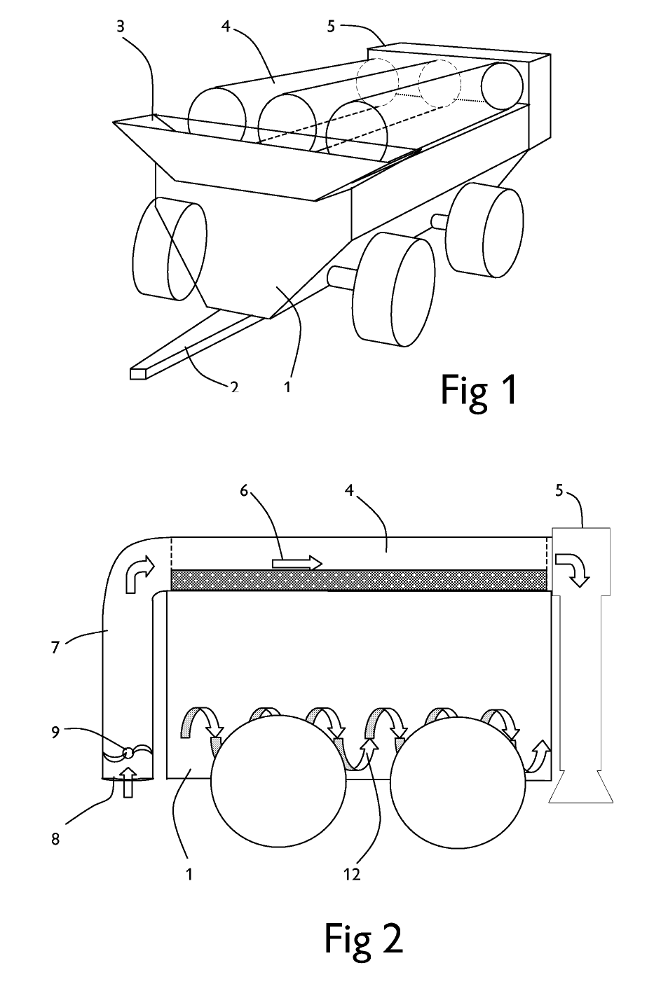

Referring to FIG. 1, a grain cart has a body 1 defining a large capacity for storing grain. The cart is designed to be towed by a tractor or the like (not shown) by means of a draw bar 2 terminating in a suitable coupling (not shown). At the upper front end of the cart is mounted a hopper 3 to receive seeds (for example grain) and associated waste material or chaff cut and threshed by a head module to substantially remove straw or stalks, such as that described in UK Patent No 2351219 mentioned above, or by any other suitable cutting and primary threshing unit.

Fitted to the top of the cart is at least one, preferably three, cylindrical cleaning devices 4. Details of their construction will be given later but it is possible for the cylinder or cylinders to be mounted to a framework (not shown) that is readily detachable from the cart body 1. In this way, the present invention may be temporarily fixed to a conventional grain cart.

Grain from the hopper 3 is fed into the forward end of the cylinders 4 and is forced through the cylinders so as to extract the grain and remove the chaff etc. The grain drops into the bottom of the cart where it can be delivered to a storage device, such as another grain cart towed or driven alongside the cart of the invention.

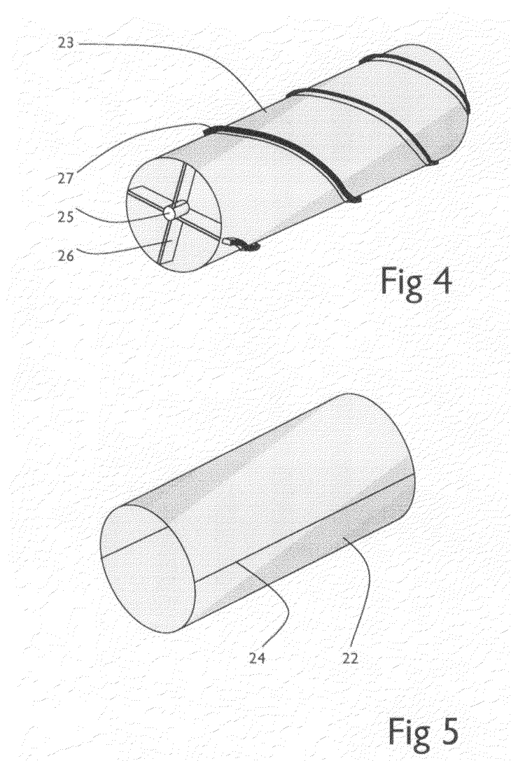

It may be convenient for the grain to be blown into the ends of the cylinders and along their insides by a flow of air of sufficient force to propel the chaff along the length of the cylinders but to let the grain fall through into the base of the cart. The process is preferably assisted by a brush arrangement that will be described later with reference to FIGS. 4 and 5. The rear ends of the cylinders are coupled to a discharge chamber 5 so that the chaff etc may be channeled into a mechanism for discharging it.

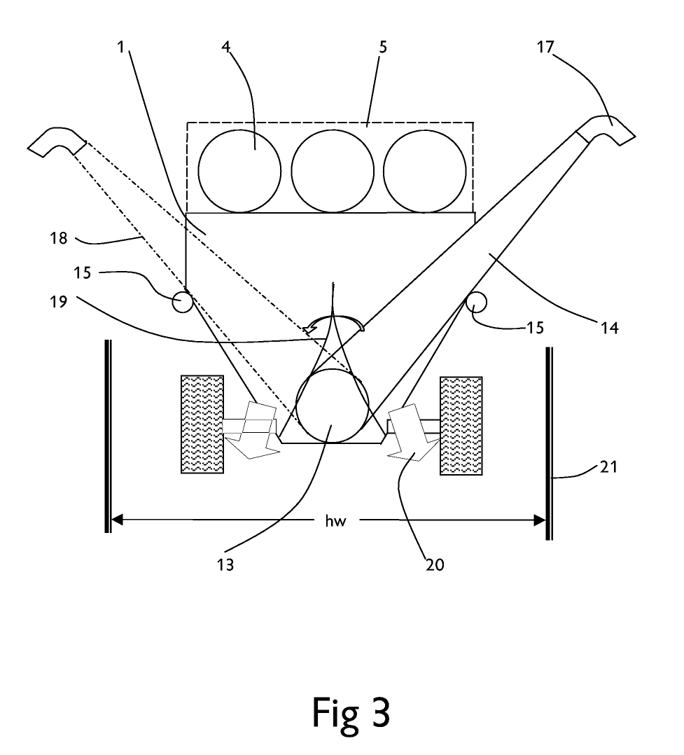

Referring now to FIG. 2, the cart is shown with the cylinders 4 along the top and connected at their front ends to an inlet tube 7 connected via inlet 8 to a source of air flow represented by fan 9. The air flow passes through the cylinders as represented by the arrows 6. It terminates in a discharge chamber 5 at the rear of the cart and from there the air flow passes through a discharge tube 10 to an outlet 11. As a consequence of this arrangement, chaff separated from grain in the cylinders is forced to the rear and discharged via the chamber 5, discharge tube 10 and outlet 11. The base of the cart may also be fitted with means for delivering grain that settles in the base to a discharge mechanism. In the preferred embodiment, the cart may be fitted with an auger of conventional construction and shown schematically by the spiral arrows 12. The grain is delivered to an exit at the rear of the cart and from there preferably through a delivery auger or the like, as will be explained with reference to FIG. 3.

Turning now to FIG. 3, which shows the rear of the cart, the discharge tube 10 has been removed for clarity. Instead, the Figure illustrates how the bottom auger 12 of FIG. 2 communicates with an exit opening 13 to feed grain into a discharge auger 14. The discharge auger 14 is constrained and supported when in its discharge position as illustrated by means of a stop 15 extending from the side of the cart. The auger 14 is mounted via a rotary coupling to the body 1 so that it can be moved to one or other side, as shown in phantom lines at 18 in the Figure. The auger 14 may be adapted to fold over on itself for transport so as not to project excessively beyond the edges of the cart. The grain exits as shown by arrows 17 and can be collected in a secondary cart. The capacity of the cart of the invention can considerably exceed that of conventional grain carts so that downtime is reduced whilst the secondary cart returns to base to empty the grain into a silo.

While the illustrated embodiment shows the delivery auger to be at the rear of the grain cart, it may be convenient to locate the auger at the front end of the cart. This may have advantages in some circumstances in controlling weight transfer during delivery of the grain to the secondary cart and thus ensuring a more controlled weight distribution. It may also be advantageous for the auger to be more readily visible to the driver of the towing vehicle. The auger could, of course, alternatively be mounted on one side of the cart.

Chaff exiting the chamber 5 can be discharged to ground via the tube 10 shown in FIG. 2, as previously described. Alternatively, the chamber 5 can extend down the back wall of the cart body 1. In this case, it is advantageous for the extended chamber 5 to be subdivided by plates or the like 20 so that the chaff can exit through one or more discharge ports shown diagrammatically by the arrows 20 (FIG. 3). Alternatively, it can be discharged over the full width of the cart, with mechanical spreading means if required to distribute over the full width of the cut.

FIGS. 4 and 5 illustrate a preferred construction for the cylinders 4. Each cylinder consists of an outer “sieve” 22 and an inner “brush” assembly 23. The sieve is a cylindrical hollow tube made of suitable material, such as stainless steel or the like, with perforations in the lower portion as indicated by the demarcation lines 24 and by the shaded portion in FIG. 2. The brush assembly 23 consists of a hollow perforated tube fitted at its ends with a bearing 25 connected by cross-bracing 26, for example, to the tube. The inner brush assembly 23 can therefore be rotated within the outer sieve by suitable drive means such as a separate motor or by power taken from the conventional tractor power take-off. Around the outer surface of the assembly 23 lie one or more brushes 27 arranges in a spiral configuration.

When the brush assembly is rotated, the brushes engage the inner surface of the sieve and dislodge/sweep away chaff and other waste matter, enabling the current of air driven through the cylinder to force the waste material to the rear of the cart and into the discharge chamber 5. Grain, being of smaller size and heavier than the waste material, falls through the perforations in the tube of the brush assembly 23 and through the lower perforated portion of the sieve and drops into the base of the cart 1. Alternatively, the brush assembly may consist of a plurality of brushes mounted on spiral supports fixed between end bearings in a space frame so that the grain has an uninterrupted passage from the cylinders to the cart, leaving the chaff within the sieve for outward passage to the chamber 6. To assist separation/cleaning, the inner surface of the sieve may be provided with spirally arranged ribs (not shown) that are engaged by the brushes 27.

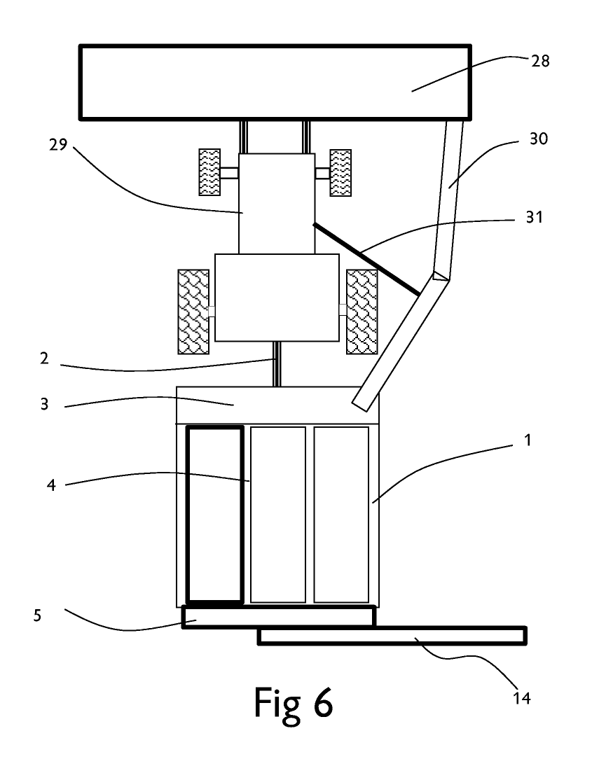

The cart of the invention may be used with the head of the above identified UK Patent. The width “hw” of the head is likely to be wider than that of the cart. Its extent is indicated generally by the vertical lines 21 in FIG. 3. This is also shown diagrammatically in FIG. 6, which illustrates in plan view the general layout of the header 28 and cart 1 relative to a tractor 29 and also indicates a suitable manner in which grain is carried from the head module and past the tractor to the cart.

A suitable conveyor 30 needs to be provided to transport the grain and chaff from the header 28 to the hopper 3 of the cart 1. This may be an air duct arranged with an air flow to force the grain into the hopper. Alternatively, a screw-feed device or mechanical belt conveyor may be used, or a bucket conveyor, all of conventional type. The conveyor 30 is attached to the tractor 29 by one or more support arms 31 that may be adjustable and/or movable to raise/lower the conveyor. The conveyor may be to one side, as illustrated, when the header 28 has a side exit, or it may be central, passing beneath, or even over, the tractor.

The conveyor preferably forms another module that can be relatively easily attached to and removed from the tractor. In this way, a complete harvesting machine can be put together, consisting of a head unit, tractor unit, conveyor and grain cart, the principle advantage being that the tractor is fully utilised, the modules are readily serviceable without putting the tractor out of service, and the need for a dedicated combine harvester that is only in use for a few weeks in a year is rendered superfluous.

1. A seed cleaning module adapted to be removably mounted on to the open upper face of a grain cart having means to deliver cleaned grain to collection means, the module comprising a cleaning stage comprising a sieve and transport means for moving harvested seeds and waste material over the surface thereof whereby the seeds fall into the cart and the waste material passes towards the rear of the cart for subsequent discharge.

2. A module according to claim 1, wherein the sieve is in the form of a cylinder and the transport means is arranged to transport said seeds and waste material along the cylinder so that the seeds can pass therethrough into said grain cart and said waste material is carried along the cylinder for subsequent discharge at the end thereof.

3. A module according to claim 2, comprising two or more of said cylinders disposed side-by-side.

4. A module according to claim 2, wherein the or each said cylinder comprises an outer tubular sleeve, at least the lower part of which is perforated to allow grain to pass therethrough, and an inner tubular structure on which are mounted brush means adapted to brush against the inner surface of said outer sleeve.

5. A module according to claim 4, wherein said inner surface of said outer sleeve is formed with a pattern of ribs to aid brushing.

6. A module according to claim 4, wherein said inner tubular structure comprises a sleeve provided with brush means on its outer surface.

7. A module according to claim 6, wherein said brush means comprises at least one brush disposed in a spiral.

8. A module according to claim 1, wherein said cart further includes a hopper located upstream of the sieve and adapted to receive seeds and waste material from a cutter.

9. A module according to claim 1, wherein said means for causing said seeds and waste material to pass through said one or more cylinders comprises means to create an air flow through the one or more cylinders.

10. A module according to claim 1, further comprising delivery means to deliver cleaned seeds to a discharge device.

11. A module according to claim 10, wherein said discharge device comprises an auger adapted to deliver said cleaned seeds to a mobile collection cart.

12. A module according to claim 11, wherein said auger is movable so as to be disposed at either side of the said module.

13. A grain cart having a seed cleaning module adapted to be removably mounted on to an open upper face of said grain cart, said module comprising:
means to deliver cleaned grain to collection means;
a cleaning stage comprising a sieve and transport means for moving harvested seeds and waste material over the surface of the cleaning stage whereby the seeds fall into the cart and the waste material passes towards the rear of the cart for subsequent discharge.

14. A grain cart according to claim 13, further provided with feeding means for feeding said cleaned seeds to said delivery means.

15. A grain cart according to claim 14, wherein said feeding means comprises an auger disposed in the base of said cart.

16. A modular harvesting machine comprising a cutting head mounted to a tractor, and a conveyor module mounted to the tractor to carry seeds and waste material cut by the cutting head to a grain cart having a seed cleaning module adapted to be removably mounted on to an open upper face of said grain cart, said module comprising:
means to deliver cleaned grain to collection means;
a cleaning stage comprising a sieve and transport means for moving harvested seeds and waste material over the surface of the cleaning stage whereby the seeds fall into the cart and the waste material passes towards the rear of the cart for subsequent discharge.

17. (canceled)
